(19) United States
(12) Patent Application Publication
(10) Pub. No.: US 2025/0095902 A1
(43) Pub. Date: Mar. 20, 2025

(54) INDUCTOR ASSEMBLY AND POWER MODULE USING THE SAME

(71) Applicant: Monolithic Power Systems, Inc., Kirkland, WA (US)

(72) Inventors: Ting Ge, San Jose, CA (US); Daocheng Huang, Santa Clara, CA (US); Zhe Yang, San Jose, CA (US); Wenyang Huang, Hangzhou (CN)

(21) Appl. No.: 18/469,847

(22) Filed: Sep. 19, 2023

(51) Int. Cl. H01F 27/26; H01F 27/30; H02M 3/00

(52) U.S. Cl. CPC H01F 27/263; H01F 27/306; H02M 3/003

(57) ABSTRACT

A power module having a bottom substrate, a device substrate arranged on the bottom substrate and an inductor assembly arranged on the device substrate. The inductor assembly has a first winding, a second winding, a first magnetic core part and a second magnetic core part. The first magnetic core part has a first portion disposed on a first horizontal level and a second portion disposed on a second horizontal level. The second magnetic core part has a first portion disposed on the second horizontal level and a second portion disposed on the first horizontal level. The first and second magnetic core parts are assembled to accommodate the first winding between the first portions of the first and second magnetic core part, and to accommodate the second winding between the second portions of the first and second magnetic core part.

### TECHNICAL FIELD

The present invention generally relates to electrical components, and more particularly but not exclusively relates to power modules.

### BACKGROUND

Power converter, as known in the art, converts an input power to an output power for providing a load with required voltage and current. Multi-phase power converter comprising a plurality of paralleled power stages operating out of phase has lower output ripple voltage, better transient performance and lower ripple-current-rating requirements for input capacitors. They are widely used in high current and low voltage applications, such as server and microprocessor.

With the development of modern GPUs (Graphics Processing Units), and CPUs (Central Processing Units), increasingly high load current is required to achieve better processor performance. Furthermore, to improve integration, the size of power modules needs to be smaller. Higher current and smaller size put more challenges to the heat conduction. Therefore, it is desirable to provide a power module with high-power density, high-efficiency and excellent heat dissipation capability in space-constrained environments.

### SUMMARY

It is an object of the present invention to provide a power module with stacked inductors and power device chips.

The embodiments of the present invention are directed to a power module. The power module includes a bottom substrate, a device substrate and an inductor assembly. The bottom substrate has a first surface and a second surface opposite to the first surface. The device substrate is arranged on the bottom substrate. The device substrate has a first surface and a second surface opposite to the first surface of the device substrate, and the second surface of the device substrate faces the first surface of the bottom substrate. The inductor assembly is arranged on the device substrate. The inductor assembly has a first surface and a second surface opposite to the first surface of the inductor assembly, and the second surface of the inductor assembly faces the first surface of the device substrate. The inductor assembly includes a first winding, a second winding, a first magnetic core part and a second magnetic core part. The first magnetic core part has a first portion disposed on a first horizontal level, a second portion disposed on a second horizontal level, and a connecting portion connecting the first portion and the second portion of the first magnetic core part. The second magnetic core part has a first portion disposed on the second horizontal level, a second portion disposed on the first horizontal level, and a connecting portion connecting the first portion and the second portion of the second magnetic core part. The first magnetic core part and the second magnetic core part are assembled to accommodate the first winding between the first portion of the first magnetic core part and the first portion of the second magnetic core part, and to accommodate the second winding between the second portion of the first magnetic core part and the second portion of the second magnetic core part.

The embodiments of the present invention are directed to an inductor assembly. The inductor assembly has a first surface and a second surface opposite to the first surface. The inductor assembly includes a first winding, a second winding, a first magnetic core part and a second magnetic core part. The first magnetic core part has a first portion disposed on a first horizontal level, a second portion disposed on a second horizontal level, and a connecting portion connecting the first portion and the second portion of the first magnetic core part. The second magnetic core part has a first portion disposed on the second horizontal level, a second portion disposed on the first horizontal level, and a connecting portion connecting the first portion and the second portion of the second magnetic core part. The first magnetic core part and the second magnetic core part are assembled to accommodate the first winding between the first portion of the first magnetic core part and the first portion of the second magnetic core part, and to accommodate the second winding between the second portion of the first magnetic core part and the second portion of the second magnetic core part. The connecting portion of the first magnetic core part and the connecting portion of the second magnetic core part are located at a central axis of the inductor assembly, and the first winding and the second winding are located on the opposite sides of the central axis of the inductor assembly.

The embodiments of the present invention are directed to an inductor assembly. The inductor assembly has a first surface and a second surface opposite to the first surface. The inductor assembly includes a first winding, a second winding, a first magnetic core part and a second magnetic core part. The first magnetic core part has a first portion disposed on a first horizontal level, a second portion disposed on a second horizontal level, and a connecting portion connecting the first portion and the second portion of the first magnetic core part. The second magnetic core part has a first portion disposed on the second horizontal level, a second portion disposed on the first horizontal level, and a connecting portion connecting the first portion and the second portion of the second magnetic core part. The first magnetic core part and the second magnetic core part are assembled to accommodate the first winding between the first portion of the first magnetic core part and the first portion of the second magnetic core part, and to accommodate the second winding between the second portion of the first magnetic core part and the second portion of the second magnetic core part. The inductor assembly provides a self-inductance of at least 60 nH for currents between 1 A and 60 A, and provides a negative mutual-inductance which has an absolute value of at least 30 nH for currents between 1 A and 60 A.

### BRIEF DESCRIPTION OF THE DRAWINGS

The present invention can be further understood with reference to the following detailed description and the appended drawings, wherein like elements are provided with like reference numerals. The drawings are only for illustration purpose. They may only show part of the devices and are not necessarily drawn to scale.

FIG. 1 schematically shows a prior art multi-phase power converter 10 which comprises a controller 101, N power devices 103 and N inductors L1 for supplying power to a load 104.

FIG. 2 shows a power module 20 for a dual-phase power converter in accordance with an embodiment of the present invention.

FIG. 3 shows a disassembled and perspective view illustrating the power module 20 of FIG. 1.

FIG. 4 shows a cross sectional view illustrating the power module 20 taken along AA′ line of FIG. 1 in accordance with an embodiment of the present invention.

FIG. 5 shows a bottom view of the inductor assembly 203 in accordance with an embodiment of the present invention.

FIG. 6 shows a top view of the device substrate 202 in accordance with an embodiment of the present invention.

FIG. 7 shows a bottom view of the device substrate 202 in accordance with an embodiment of the present invention.

FIG. 8 shows a bottom view of the bottom substrate 201 in accordance with an embodiment of the present invention.

FIG. 9 is a side view illustrating a system 90 employing the power module 20 in accordance with an embodiment of the present invention.

FIG. 10 shows a dissembled view of an inductor assembly 100 in accordance with an embodiment of the present invention.

FIG. 11 shows a flux path P1 induced by a predetermined current I1 flowing through the first winding 1002 in accordance with an embodiment of the present invention.

FIG. 12 shows a flux path P2 induced by a predetermined current I2 flowing through the second winding 1003 in accordance with an embodiment of the present invention.

FIG. 13 is an illustration for the size of the inductor assembly 100 in accordance with an embodiment of the present invention.

FIG. 14 shows a front view of an inductor assembly 140 in accordance with an embodiment of the present invention.

FIG. 15 shows a front view of an inductor assembly 150 in accordance with an embodiment of the present invention.

FIG. 16A plots a current-inductance profile for the inductor assembly 100 as shown in FIG. 10 in accordance with an embodiment of the present invention.

FIG. 16B plots a current-inductance profile for an inductor assembly 150, in accordance with an embodiment of the present invention.

FIG. 16C plots a current-inductance profile for the inductor assembly 203 as shown in FIG. 3 with a whole piece magnetic core implemented by FeSiAl in accordance with an embodiment of the present invention.

FIG. 17 shows an inductor assembly 170 in accordance with an embodiment of the present invention.

### DETAILED DESCRIPTION

In the present disclosure, numerous specific details are provided, such as examples of electrical circuits and components, to provide a thorough understanding of embodiments of the invention. Persons of ordinary skill in the art will recognize, however, that the invention can be practiced without one or more of the specific details. It is noted that, for purposes of illustrative clarity, certain elements in the drawings may not be drawn to scale. In other instances, well-known details are not shown or described to avoid obscuring aspects of the invention.

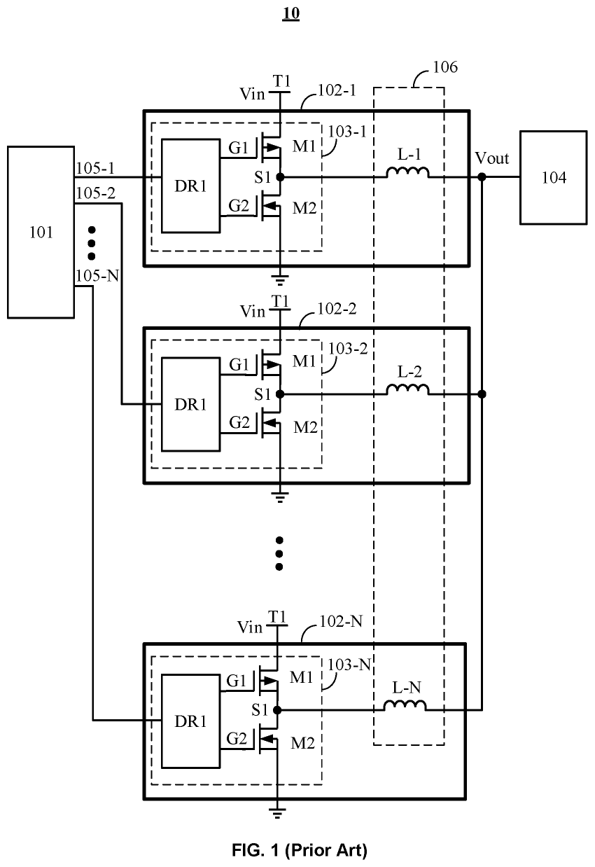

FIG. 1 schematically shows a prior art multi-phase power converter 10 which comprises a controller 101, N power blocks 103-1˜103-N and N inductors L-1˜L-N for supplying power to a load 104, wherein N is an integer, and N≥1. Each power block 103 and one inductor L represent one power stage, i.e., one phase 102 of the power converter 10, as shown in FIG. 1. Each power block 103 includes switches M1, M2 and a driver DR1 for providing driving signals G1 and G2 to drive the switches M1 and M2 respectively. The controller 101 provides N phase control signals 105-1˜105-N respectively to N power blocks 103-1˜103-N to control the N phases 102-1˜102-N working out of phase, i.e., each one of the inductors L-1˜L-N sequentially absorb power from the input source and sequentially deliver power to the load 104. It should be noticed that the outputs of all phases as shown in FIG. 1 are connected to work as a multi-phase converter. However, each phase output may be separated to work as multiple independent converters which could have different output voltage levels for different load demands.

The power stage 102 with Buck topology is shown in FIG. 1 for example. Persons of ordinary skill in the art should appreciate that power stages with other topologies, like Boost topology, Buck-Boost topology could also be adopted in a multi-phase power converter.

The inductors L-1˜L-N could be implemented by one or a few coupled inductors or could be implemented by N single inductors.

When N=2, the multi-phase power converter 10 is used as a dual-phase power converter or two separate single-phase converters. For the ease of description, dual-phase power module for a dual-phase power converter is discussed as an example to illustrate the present invention.

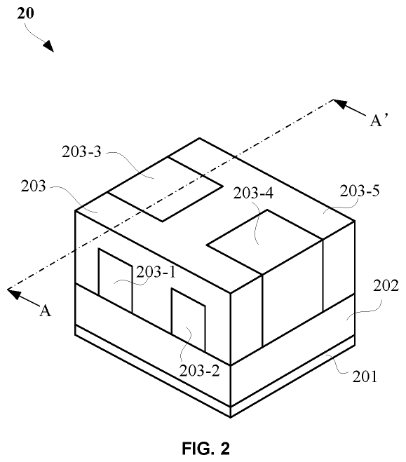

FIG. 2 shows a power module 20 for a dual-phase power converter in accordance with an embodiment of the present invention. The power module 20 may serve as the power stage 102 of FIG. 1, with N=2. The power module 20 includes a bottom substrate 201, a device substrate 202 and an inductor assembly 203. The bottom substrate 201 is arranged at the bottom of the power module 20. The device substrate 202 is arranged on the bottom substrate 201. The inductor assembly 203 is arranged on the device substrate 202. Power device chips integrating the components of the power blocks 103 shown in FIG. 1 is embedded within the device substrate 202. The inductors L are integrated in the inductor assembly 203.

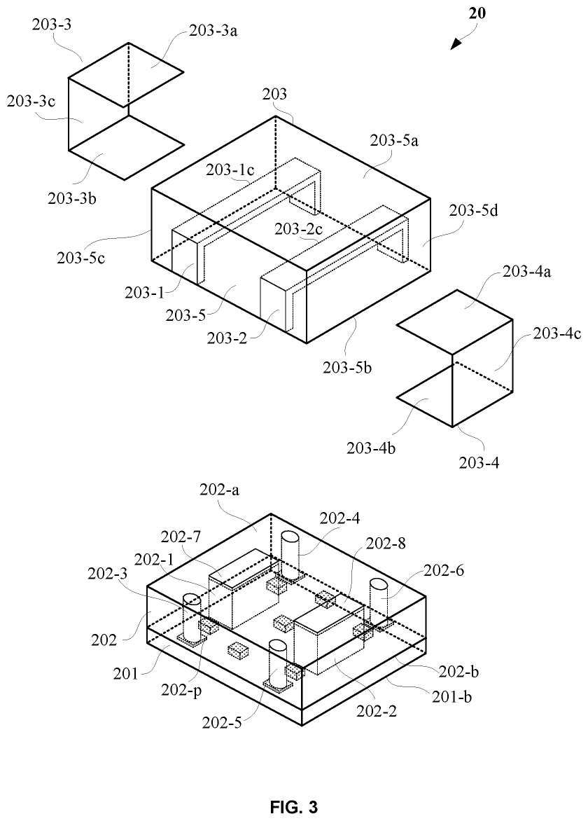

FIG. 3 shows a disassembled and perspective view illustrating the power module 20 of FIG. 2. As shown in FIG. 3, the device substrate 202 includes a first power device chip 202-1, a second power device chip 202-2, a first pair of connecting pillars 202-3 and 202-4, a second pair of connecting pillars 202-5 and 202-6, and a plurality of discrete components 202-p embedded within the device substrate 202. Each one of the first power device chip 202-1 and the second power device chip 202-2 integrates one power block 103 in FIG. 1, which includes the switches M1, M2, the driver DR1, and further integrates some auxiliary circuits not shown in FIG. 1. The first pair of the connecting pillars includes a first connecting pillar 202-3 and a second connecting pillar 202-4 arranged at opposite sides of the first power device chip 202-1. The second pair of the connecting pillars includes a third connecting pillar 202-5 and a fourth connecting pillar 202-6 arranged at opposite sides of the second power device chip 202-2. Each one of the connecting pillars has a first end connecting out of the device substrate 202, and connected to the corresponding winding of the inductor assembly 203, and a second end connected to the bottom substrate 201. The connecting pillars shown in the example of FIG. 3 are cylinders. It should be appreciated that any shape of the connecting pillars is applicable to the present invention. The discrete components 202-p include resistors and capacitors of the power converter 10, like the input capacitors at the input terminal T1 of the power converter 10 for receiving the input voltage Vin to provide pulse current, the filter capacitors and resistors for the drivers DR1 and internal logic circuits power supplies (not shown in FIG. 1), etc.

In the example of FIG. 3, the inductor assembly 203 includes a magnetic core 203-5, a first winding 203-1 and a second winding 203-2 passing through the magnetic core 203-5. The first winding 203-1 and the magnetic core 203-5 form a first inductor L-1 as shown in FIG. 1. The second winding 203-2 and the magnetic core 203-5 form a second inductor L-2 as shown in FIG. 1. Furthermore, the inductor assembly 203 includes a first heat sink layer 203-3 and a second heat sink layer 203-4, each of which has a “C” shape, and partially wraps the magnetic core 203-5. As can be seen from FIG. 3, the first heat sink layer 203-3 has a first portion 203-3a partially covering a first surface 203-5a of the magnetic core 203-5, a second portion 203-3b partially covering a second surface 203-5b of the magnetic core 203-5, and a third portion 203-3c connecting the first portion 203-3a and the second portion 203-3b, and partially covering a third surface 203-5c of the magnetic core 203-5, wherein the first surface 203-5a and the second surface 203-5b are opposite, and the third surface 203-5c is vertical to the first surface 203-5a and the second surface 203-5b. The second heat sink layer 203-4 has a first portion 203-4a partially covering the first surface 203-5a, a second portion 203-4b partially covering the second surface 203-5b, and a third portion 203-4c connecting the first portion 203-4a and the second portion 203-4b, and covering a fourth surface 203-5d of the magnetic core 203-5, wherein the fourth surface 203-5d is opposite to the third surface 203-5c, and is vertical to the first surface 203-5a and the second surface 203-5b of the magnetic core 203-5. The surfaces of the magnetic core 203-5 are also referred as surfaces of the inductor assembly module 203. It should be appreciated that the first heat sink layer 203-3 and the second heat sink layer 203-4 are configured for transferring heat from the power device chips to the environment or external components. The shape of the first heat sink layer 203-3 and the second heat sink layer 203-4 may be varying in different applications, e.g., the first heat sink layer 203-3 may have a “L” shape with the second portion 203-3b and the third portion 203-3c, and similarly, the second heat sink layer 203-4 may have a “L” shape with the second portion 203-4b and the third portion 203-4c.

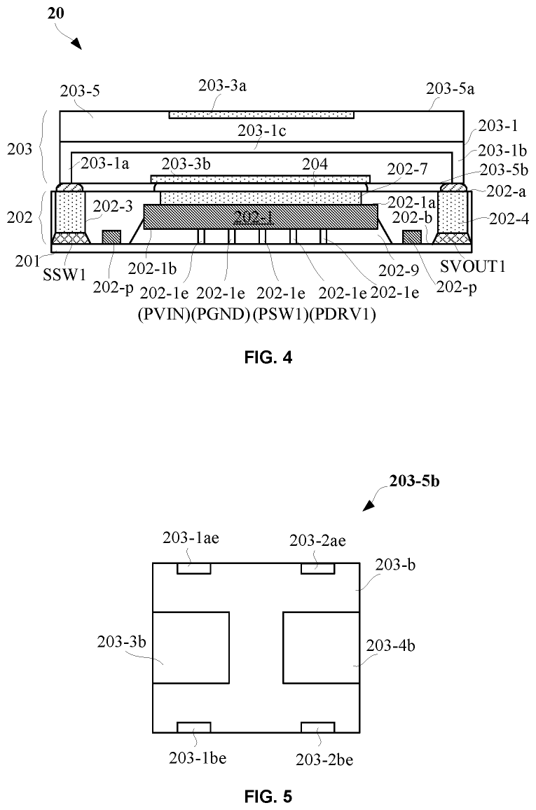

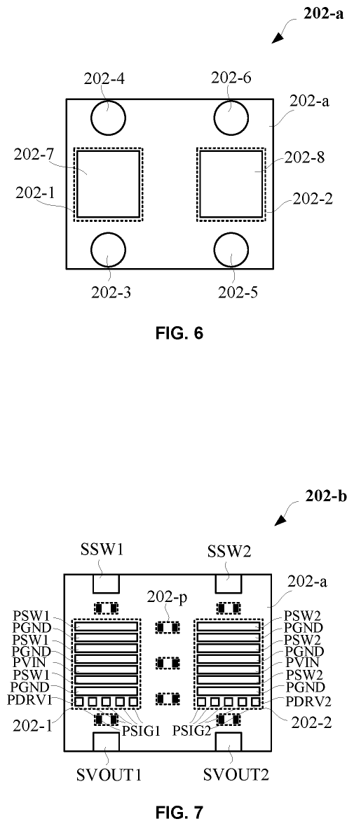

FIG. 4 shows a cross sectional view illustrating the power module 20 taken along AA′ line of FIG. 2 in accordance with an embodiment of the present invention. FIG. 5 shows a bottom view of the inductor assembly 203, i.e., the second surface 203-5b of the inductor assembly 203, in accordance with an embodiment of the present invention. FIG. 6 shows a top view of the device substrate 202, i.e., the first surface 202-a of the device substrate 202, in accordance with an embodiment of the present invention. FIG. 7 shows a bottom view of the device substrate 202, i.e., the second surface 202-b of the device substrate 202, in accordance with an embodiment of the present invention. The structure of the power module 20 will be illustrated with reference to FIGS. 3˜7.

As shown in FIG. 4, the first power device chip 202-1 has a first surface 202-1a and a second surface 202-1b. The first surface 202-1a is covered by a top heat layer 202-7 as shown in FIGS. 4 and 6, and the second surface 202-1b has a plurality of pins 202-1e (including pins PVIN, PGND, PSW1, PDRV1, and etc.) exposed on the second surface 202-b of the device substrate 202 as shown in FIGS. 4 and 7, and connected to the bottom substrate 201. Similarly, The first surface 202-2a of the second power device chip 202-2 is covered by a top heat layer 202-8 as shown in FIG. 6, and the second surface 202-2b of the second power device chip 202-2 has a plurality of pins 202-2e (including pins PVIN, PGND, PSW2, PDRV2, and etc.) exposed on the second surface 202-b of the device substrate 202 as shown in FIG. 7, and connected to the bottom substrate 201. It should be appreciated that the pins shown in FIGS. 4 and 7 are for illustration purpose. More pins may be configured in a real application. Furthermore, the pin shape, the pin size and the pin distribution would be varying in different applications. The top heat layer 202-7 and the top heat layer 202-8 are heat disposal layers, which are made of copper in one embodiment, and are made of other material in other embodiments. Persons of ordinary skill in the art should appreciate that any suitable layer configured to transfer heat from the power device chip is applicable as the top heat layer. In one embodiment, the first portion 203-3a of the first heat sink layer 203-3 and the first portion 203-4a of the second heat sink layer 203-4 are extending to each other and merged as one piece. In one embodiment, the second portion 203-3b of the first heat sink layer 203-3 and the second portion 203-4b of the second heat sink layer 203-4 are extending to each other and merged as one piece. In one embodiment, the first portion 203-3a of the first heat sink layer 203-3 and the first portion 203-4a of the second heat sink layer 203-4 are removed, and a heat radiator may remove heat from the first power device chip 202-1 and the second power device chip 202-2 via the third portion 203-3c of the first heat sink layer 203-3 and the third portion 203-4c of the second heat sink layer 203-4. Similarly, the top heat layer 202-7 and the top heat layer 202-8 could be merged as a whole piece.

As mentioned before, the first power device chip 202-1 integrates the switches M1, M2, the driver DR1 shown in FIG. 1, and other accessory circuits not shown in FIG. 1. The plurality of pins 202-1e of the first power device chip 202-1 includes at least an input pin PVIN, a switching pin PSW1, a ground pin PGND, and a driving pin PDRV1 as shown in FIG. 7. The first switch M1 has a first terminal coupled to the input pin PVIN (corresponding to the input terminal T1 in FIG. 1) to receive the input voltage Vin (shown in FIG. 1), a second terminal connected to the switching pin PSW1 (corresponding to the switching terminal S1 in FIG. 1), and a control terminal configured to receive a first driving signal G1. The second switch M2 has a first terminal connected to the switching pin PSW1, a second terminal connected to the ground pin PGND, and a control terminal configured to receive a second driving signal G2. The driver DR1 is coupled to the driving pin PDRV1 to receive a phase control signal 105, and to provide the first driving signal G1 and the second driving signal G2 based on the phase control signal 105. The plurality of pins of the power device chips 202-1 and 202-2 are electrically connected to external circuits/devices/components via the bottom substrate 201. The bottom substrate 201 may be attached to a mainboard where the load (CPU, GPU, etc.) located, and there may be circuits/devices/components on the mainboard providing the input voltage Vin, the phase control signal 105, and a ground reference GND that provides a common ground for the first power device chip 202-1 and the second power device chip 202-2 via the ground pins PGND.

It should be appreciated that the second power device chip 202-2 has the same structure as the first power device chip 202-1, and is not discussed for the brevity of description.

The first winding 203-1 and the second winding 203-2 are embedded in the magnetic core 203-5 and have an upside-down “U” shape, and are parallel to each other. In the example shown in FIG. 4, the first winding 203-1 has a first portion 203-1a and a second portion 203-1b having ends 203-1ae and 203-1be connected out of the second surface 203-5b of the magnetic core 203-5, and has a middle portion 203-1c parallel to the first surface 203-5a of the magnetic core 203-5 and connecting the first portion 203-1a and the second portion 203-1b. The end 203-1ae of the first portion 203-1a of the first winding 203-1 connects out of the second surface 203-5b of the magnetic core 203-5 as shown in FIG. 5, and is electrically connected to the first connecting pillar 202-3 embedded within the device substrate 202 by soldering or other connecting means as shown in FIG. 4. The end 203-1be of the second portion 203-1b of the first winding 203-1 connects out of the second surface 203-5b of the magnetic core 203-5 as shown in FIG. 5, and is electrically connected to the second connecting pillar 202-4 embedded within the device substrate 202 by soldering or other connecting means as shown in FIG. 4. It should be appreciated that the second winding 203-2 has the similar structure with the first winding 203-1 as shown in FIG. 3, and has two ends 203-2ae and 203-2be electrically connected to third connecting pillar 202-5 and the fourth connecting pillar 202-6 respectively.

The second portion 203-3b of the first heat sink layer 203-3 partially covers the second surface 203-5b of the magnetic core 203-5 as shown in FIG. 5, and is attached to the top heat layer 202-7 directly or via a heat conductive contact 204 as shown in the example of FIG. 4. Similarly, the second portion 203-4b of the second heat sink layer 203-4 partially covers the second surface 203-5b of the magnetic core 203-5 as shown in FIG. 5, and is attached to a top heat layer on top of the second power device chip 202-2 directly or via a heat conductive contact. In one embodiment, the heat sink layers 203-3 and 203-4 are made of copper, and dissipate heat from the top heat layers on top of the power device chips 202-1 and 202-2. Consequently, the heat of the power device chips 202-1 and 202-2 are dissipated via the top heat layers 202-7 and 202-8 and the heat sink layer 203-3 and 203-4, respectively. The heat sinks 203-3 and 203-4 are attached to the magnetic core 203-5 by either thermal glue, thermal paste, or direct contact.

The first connecting pillar 202-3 has one end connecting out of the first surface 202-a of the device substrate 202 as shown in FIG. 6, and connected to the end of the first portion 203-1a of the first winding 203-1 as shown in FIG. 4, and has the other end connected to the bottom substrate 201 via a first switching terminal SSW1. Furthermore, the end of the first portion 203-1a of the first winding 203-1, and the first connecting pillar 202-3, are electrically connected to the switching pin PSW1 of the first power device chip 202-1 via conductive traces inside the bottom substrate 201. Consequently, the heat of the first power device chip 202-1 is further dissipated through the first connecting pillar 202-3 and the first winding 203-1. The second connecting pillar 202-4 has one end connecting out of the first surface 202-a of the device substrate 202 and connected to the end of the second portion 203-1b of the first winding 203-1, and has the other end connected to the bottom substrate 201 via a first output voltage terminal SVOUT1. The third connecting pillar 202-5 has one end connecting out of the first surface 202-a of the device substrate 202 as shown in FIG. 6, and connected to the end 203-2ae of the first portion 203-2a of the second winding 203-2 shown in FIG. 5, and has the other end connected to the bottom substrate 201 via a second switching terminal SSW2. The end 203-2ae of the first portion 203-2a of the second winding 203-2, and the third connecting pillar 202-5, are electrically connected to the switching pin PSW2 of the second power device chip 202-2 via conductive traces inside the bottom substrate 201. Consequently, the heat of the second power device chip 202-2 is further dissipated through the third connecting pillar 202-5 and the second winding 203-2. The fourth connecting pillar 202-6 has one end connecting out of the first surface 202-a of the device substrate 202 and connected to the end 203-2be of the second portion 203-2b of the second winding 203-2, and has the other end connected to the bottom substrate 201 via a second output voltage terminal SVOUT2. In some embodiments of the present invention, the connecting pillars 202-3˜202-6 are soldered to the bottom substrate 201, and the first switching terminal SSW1, the first output voltage terminal SVOUT1, the second switching terminal SSW2 and the second output voltage terminal SVOUT2 are solder pastes at the ends of the connecting pillars 202-3˜202-6. It should be appreciated that the connecting pillars 202-3˜202-6 may be connected to the bottom substrate 201 directly, or by other connecting means known in the art, e.g., the connecting pillars 202-3˜202-6 may be protruded out of the bottom surface 202-b of the device substrate 202, and are inserted to grooves of the bottom substrate 201.

As shown in FIG. 7, the first power device chip 202-1 has signal pins PSIG1 which may be configured to transmit temperature monitoring signal, current monitoring signal, and other necessary signals for communicating between the first power device chip 202-1 and external circuits. The second power device chip 202-2 has signal pins PSIG2 which may be configured to transmit temperature monitoring signal, current monitoring signal, and other necessary signals for communicating between the second power device chip 202-2 and external circuits. In FIG. 7, the driving pin PDRV1 is illustrated as an example of signal pins PSIG1, and the driving pin PDRV2 is illustrated as an example of signal pins PSIG2. Other signal pins, like the pins for transmitting the temperature monitoring signal, the current monitoring signal, etc., are not specifically labeled for brevity. The discrete components 202-p together with the power device chips 202-1 and 202-2 which are molded within the device substrate 202 have connecting terminals on the second surface of the device substrate 202. As shown in the embodiment of FIG. 7, each one of the discrete components 202-p, i.e., the capacitors and the resistors, has two pins or pads exposed on the second surface 202-b of device substrate 202, and connected to the bottom substrate 201, wherein the discrete components 202-p are electrically connected to the power device chips 202-1, 202-2, and external components/circuits via the bottom substrate 201. Persons of ordinary skill in the art should know that the pins shown in FIG. 7 are for illustrating, which should not be limiting the present invention. The pin distribution on the second surface of the device substrate 202 is determined by the requirement of the application specs, and is varying in different applications.

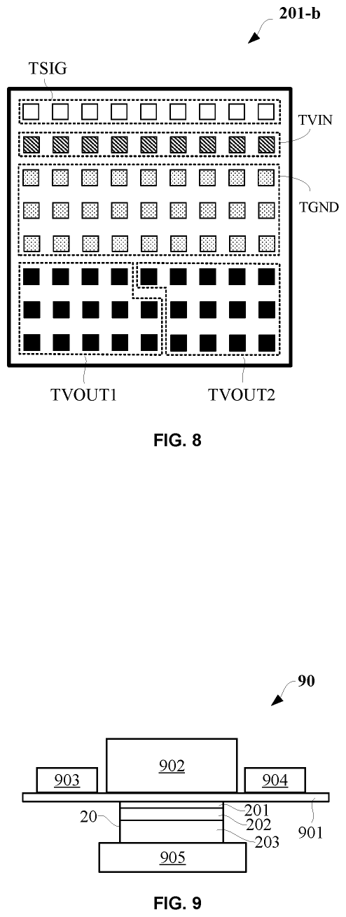

FIG. 8 shows a bottom view of the bottom substrate 201, i.e., the second surface 201-b of the bottom substrate 201, in accordance with an embodiment of the present invention. The second surface 201-b of the bottom substrate 201 includes a signal pad area TSIG, an input pad area TVIN, a ground pad area TGND, a first output voltage pad area TVOUT1 and a second output voltage pad area TVOUT2. Each one of the pad areas includes a plurality of pads. The pads on the second surface 201-b of the bottom substrate 201 connect through to the first surface 201-a of the bottom substrate 201 using, e.g., vias and conductive traces inside the bottom substrate 201. The plurality of pads of the signal pad area TSIG are electrically connected to the signal pins PSIG1 of the first power device chip 202-1 and the signal pins PSIG2 of the second power device chip 202-2 respectively, like the driving pins PDRV1, PDRV2, temperature monitoring pins, etc. The plurality of pads of the input pad area TVIN are electrically connected to the input pins PVIN of the first power device chip 202-1 and the second power device chip 202-2. The plurality of pads of the ground pad area TGND are electrically connected to the ground pins PGND of the first power device chip 202-1 and the second power device chip 202-2. The plurality of pads of the first output voltage pad area TVOUT1 are electrically connected to the end of the second portion 203-1b of the first winding 203-1 via the second connecting pillar 202-4. The plurality of pads of the second output voltage pad area TVOUT2 are electrically connected to the end of the second portion 203-2b of the second winding 203-2 via the fourth connecting pillar 202-6. In one embodiment, the pads of the first output voltage pad area TVOUT1 and the pads of the second output voltage pad area TVOUT2 are electrically disconnected, which makes the power module 20 work as two independent converters. In some embodiments, the pads of the first output voltage pad area TVOUT1 and the pads of the second output voltage pad area TVOUT2 are electrically connected by external conductive traces or traces inside the bottom substrate, which makes the power module 20 work as a dual-phase power converter.

In the present invention, by stacking the bottom substrate 201, the device substrate 202 and the inductor assembly 203 vertically, the power density is increased. The first portions and the second portions of the first winding and the second winding are exposed to the side surfaces of the magnetic core as shown in the embodiments of the present invention. It should be appreciated that the first portions and the second portions of the first winding and the second winding could be totally embedded inside the magnetic core, thereby switching noise is shielded by the magnetic core 205 and the device substrate 202 of the power module 20, thus better noise immunity is provided compared to the prior art power modules.

In the present invention, the power device chips embedded within the device substrate dissipate heat from the top, i.e., through the top heat layers, and meanwhile from the bottom, i.e., through the pins attached to the bottom substrate, and then further through the windings and magnetic core of the inductor assembly, which makes the heat dissipation performance excellent.

In one embodiment, the device substrate 202 is formed by firstly attaching the power device chips 202-1 and 202-2, the discrete components 202-p, and the connecting pillars 202-3˜202-6 to the bottom substrate 201, and secondly molding all the aforementioned components together. The power module 20 could be produced by stacking the inductor assembly module 203 on top (first surface 202-a) of the device substrate 202, which highly eases the manufacturability and improves the robustness.

It should be appreciated that the device substrate 202 could also be implemented by other means, e.g., by PCB (Printed Circuit Board) process. Specifically, the power device chips 202-1 and 202-2, the discrete components 202-p, and the connecting pillars 202-3˜202-6 could be integrated in a PCB or be embedded by several PCB layers.

In one embodiment, the bottom substrate 201 is implemented by a PCB layer.

FIG. 9 is a side view illustrating a system 90 employing the power module 20 in accordance with an embodiment of the present invention. The system 90 includes a mainboard 901, a load 902, external components 903, 904, the power module 20, and a heat radiator 905. In the embodiment of FIG. 9, the load 902 and the power module 20 are attached to the opposite surfaces of the mainboard 901, which shorts the power delivery path, and improves the power efficiency. The load 902 may be a CPU, a GPU, or any other microprocessors. The power module 20 is attached to the mainboard 901 by the bottom substrate 201. The top of the power module 20 is covered by the heat radiator 905 for heat dissipation. The external components 903 and 904 may be the devices providing power, i.e., the input voltage Vin, or providing the phase control signals 105, to the power module 20. In other embodiments, the power module 20 and the load 902 may be placed on the same surface of the mainboard 901.

The power module for the dual-phase power converter is described for illustrating the present invention. It should be appreciated that the power module in the present invention could be scaled in by including a single power device chip and a single inductor to implement a single-phase power converter, or be scaled out by including more power device chips and inductors to implement multiple power converters or a multi-phase power converter.

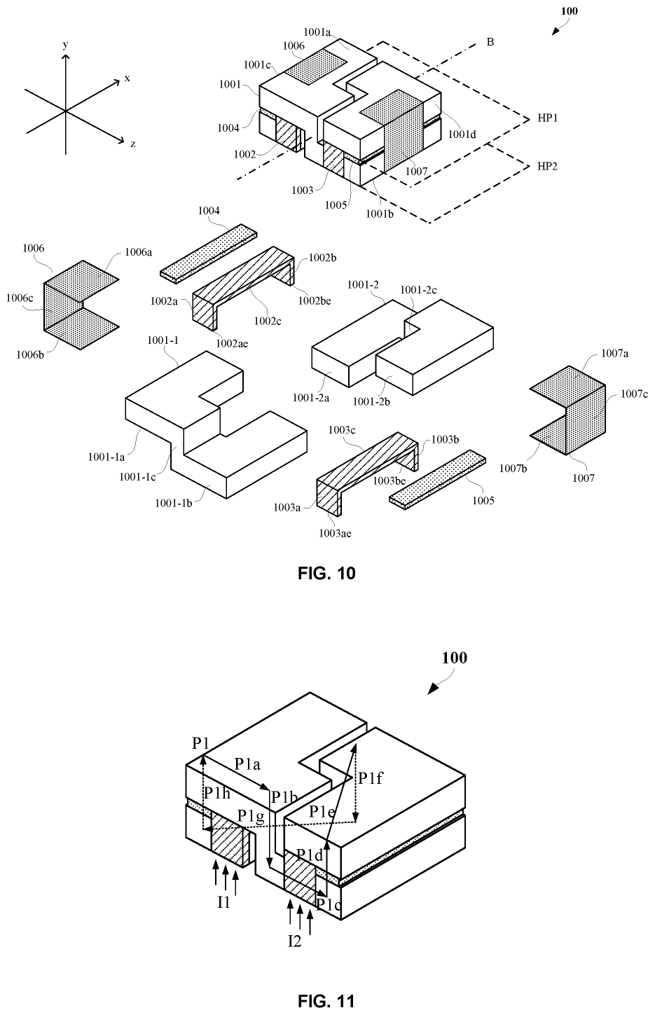

FIG. 10 shows a dissembled view of an inductor assembly 100 in accordance with an embodiment of the present invention. The inductor assembly 100 includes a magnetic core 1001, a first winding 1002 and a second winding 1003. The magnetic core 1001 includes a first magnetic core part 1001-1 and a second magnetic core part 1001-2. The first magnetic core part 1001-1 has a “Z” shape projection in a first direction “x”, and the second magnetic core part 1001-2 has a backwards “Z” shape projection in the first direction “x”, wherein the first magnetic core part 1001-1 and the second magnetic core part 1001-2 are interlaced as shown in FIG. 10. Specifically, the first magnetic core part 1001-1 has a first portion 1001-1a disposed on a first horizontal level “HP1”, a second portion 1001-1b disposed on a second horizontal level “HP2”, and a connecting portion 1001-1c connecting the first portion 1001-1a and the second portion 1001-1b of the first magnetic core part 1001-1. The second magnetic core part 1001-2 has a first portion 1001-2a disposed on the second horizontal level “HP2”, a second portion 1001-2b disposed on the first horizontal level “HP1”, and a connecting portion 1001-2c connecting the first portion 1001-2a and the second portion 1001-2b of the second magnetic core part 1001-2. The connecting portion 1001-1c of the first magnetic core part 1001-1 and the connecting portion 1001-2c of the second magnetic core part 1001-2 are located at a central axis “B” of the inductor assembly 100, and the first winding 1002 and the second winding 1003 are located on the opposite sides of the central axis “B” of the inductor assembly 100. The first magnetic core part 1001-1 and the second magnetic core part 1001-2 are assembled as a cube to accommodate the first winding 1002 between the first portion 1001-1a of the first magnetic core part 1001-1 and the first portion 1001-2a of the second magnetic core part 1001-2, and to accommodate the second winding 1003 between the second portion 1001-1b of the first magnetic core part 1001-1 and the second portion 1001-2b of the second magnetic core part 1001-2.

Both the first winding 1002 and the second winding 1003 have an upside-down “U” shape. The first winding 1002 has a first portion 1002a, a second portion 1002b and a third portion 1002c. The third portion 1002c connects the first portion 1002a and the second portion 1002b, thus is also referred as the middle portion of the first winding 1002. The first portion 1002a and the second portion 1002b are parallel and have lengths perpendicular to the third portion 1002c. The first winding 1002 has a first end 1002ae and a second end 1002be connected out of a second surface 1001b of the magnetic core 1001, i.e., the second surface of the inductor assembly 100. Similarly, the second winding 1003 has a first portion 1003a, a second portion 1003b and a third portion 1003c. The third portion 1003c connects the first portion 1003a and the second portion 1003b, thus is also referred as the middle portion of the second winding 1003. The first portion 1003a and the second portion 1003b are parallel and have lengths perpendicular to the third portion 1003c. The second winding 1003 has a first end 1003ae and a second end 1003be connected out of a second surface 1001b of the magnetic core 1001, i.e., the second surface of the inductor assembly 100. When the inductor assembly 100 is used with the power module 20 shown in FIG. 3, the first end 1002ae of the first winding 1002 is connected/attached to the first connecting pillar 202-3, and via the first connecting pillar 202-3 and the conductive traces inside the bottom substrate 201, the first end 1002ae of the first winding 1002 is electrically connected to the switching pin PSW1 of the first power device chip 202-1. The second end 1002be of the first winding 1002 is connected/attached to the second connecting pillar 202-4, and via the second connecting pillar 202-4 and the conductive traces inside the bottom substrate 201, the second end 1002be of the first winding 1002 is electrically coupled to the pads of the first output voltage pad area TVOUT1. The first end 1003ae of the second winding 1003 is connected/attached to the third connecting pillar 202-5, and via the third connecting pillar 202-5 and the conductive traces inside the bottom substrate 201, the first end 1003ae of the second winding 1003 is electrically connected to the switching pin PSW2 of the second power device chip 202-2. The second end 1003be of the second winding 1003 is connected/attached to the fourth connecting pillar 202-6, and via the fourth connecting pillar 202-6 and the conductive traces inside the bottom substrate 201, the second end 1003be of the second winding 1003 is electrically coupled to the pads of the second output voltage pad area TVOUT2. The middle portion 1002c of the first winding 1002 and the middle portion 1003c of the second winding 1003 are parallel to the first surface 202-a of the device substrate 202 in the embodiment shown in FIG. 10.

In the embodiment of FIG. 10, the inductor assembly 100 further includes a first magnetic layer 1004 and a second magnetic layer 1005. The first magnetic layer 1004 is located between the first portion 1001-1a of the first magnetic core part 1001-1 and the first portion 1001-2a of the second magnetic core part 1001-2, and alongside the middle portion 1002c of the first winding 1002. The first magnetic layer 1001-4 has a length extending along the first direction “x”. Similarly, the second magnetic layer 1005 is located between the second portion 1001-1b of the first magnetic core part 1001-1 and the second portion 1001-2b of the second magnetic core part 1001-2, and alongside the middle portion 1003c of the second winding 1003. The second magnetic layer 1001-5 has a length extending along the first direction “x”. The first magnetic layer 1004 is filled in the gap between the first portions of the first magnetic core part 1001-1 and the second magnetic core part 1001-2. The second magnetic layer 1005 is filled in the gap between the second portions of the first magnetic core part 1001-1 and the second magnetic core part 1001-2. The first magnetic layer 1004 and the second magnetic layer 1005 provide magnetic paths between the first magnetic core part 1001-1 and the second magnetic core part 1001-2.

As shown in FIG. 10, the inductor assembly 100 further includes a first heat sink layer 1006 and a second heat sink layer 1007, both of which have “C” shapes partially wrapping the inductor assembly 100. The first heat sink layer 1006 has a first portion 1006a partially covering the first surface 1001a of the inductor assembly 100, a second portion 1006b partially covering the second surface 1001b of the inductor assembly 100, and a third portion 1006c partially covering the third surface 1001c of the inductor assembly 100. The second heat sink layer 1007 has a first portion 1007a partially covering the first surface 1001a of the inductor assembly 100, a second portion 1007b partially covering the second surface 1001b of the inductor assembly 100, and a third portion 1007c partially covering the fourth surface 1001d of the inductor assembly 100. The third surface 1001c and the fourth surface 1001d of the inductor assembly 100 are opposite and vertical to the first surface 1001a and the second surface 1001b of the inductor assembly 100. When the inductor assembly 100 is applied to the power module 20 in FIG. 3, the second portion 1006b of the first heat sink layer 1006 is attached to the top heat layer 202-7 atop the first power device chip 202-1, and the second portion 1007b of the second heat sink layer 1007 is attached to the top heat layer 202-8 atop the second power device chip 202-2. In one embodiment, the first portion 1006a of the first heat sink layer 1006 and the first portion 1007a of the second heat sink layer 1007 are extending to each other and merged as one piece. In one embodiment, the second portion 1006b of the first heat sink layer 1006 and the second portion 1007b of the second heat sink layer 1007 are extending to each other and merged as one piece. In one embodiment, the first portion 1006a of the first heat sink layer 1006 and the first portion 1007a of the second heat sink layer 1007 are removed, and a heat radiator may remove heat from the first power device chip 202-1 and the second power device chip 202-2 via the third portion 1006c of the first heat sink layer 1006 and the third portion 1007c of the second heat sink layer 1007. Similarly, the top heat layer 202-7 and the top heat layer 202-8 could be merged as a whole piece. The shape of the first heat sink layer 1006 and the second heat sink layer 1007 may be varying in different applications, e.g., the first heat sink layer 1006 may have a “L” shape with the second portion 1006b and the third portion 1006c, and similarly, the second heat sink layer 1007 may have a “L” shape with the second portion 1007b and the third portion 1007c.

FIG. 11 shows a flux path P1 induced by a predetermined current I1 flowing through the first winding 1002 in accordance with an embodiment of the present invention. As shown in FIG. 11, the current I1 flows through the first winding 1002 in a direction from the first portion 1002a to the second portion 1002b. According to Ampere's rule, the flux path P1 induced by the current I1 is along the arrow direction as shown in FIG. 11. Specifically, the flux flows along the direction P1a through the first portion 1001-1a of the first magnetic core part 1001-1, the direction P1b through the connecting portion 1001-1c of the first magnetic core part 1001-1, the direction P1c through the second portion 1001-1b of the first magnetic core part 1001-1, the direction P1d through the second magnetic layer 1005, the direction P1e through the second portion 1001-2b of the second magnetic core part 1001-2, the direction P1f through the connecting portion 1001-2c of the second magnetic core part 1001-2, the direction P1g through the first portion 1001-2a of the second magnetic core part 1001-2, and the direction P1h through the first magnetic layer 1004, back to the first portion 1001-1a of the first magnetic core part 1001-1, forming the closed flux path P1.

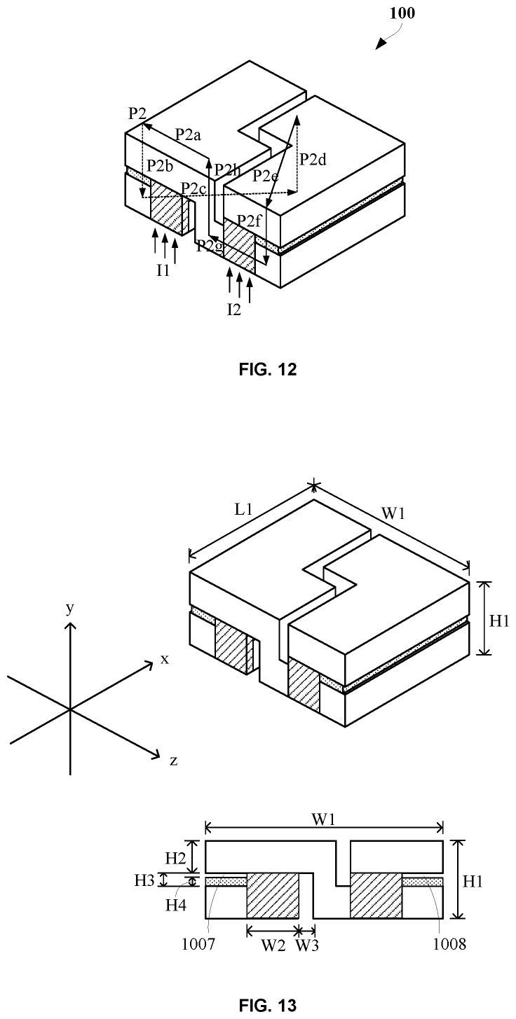

FIG. 12 shows a flux path P2 induced by a predetermined current I2 flowing through the second winding 1003 in accordance with an embodiment of the present invention. As shown in FIG. 12, the current I2 flows through the second winding 1003 in a direction from the first portion 1003a to the second portion 1003b. According to Ampere's rule, the flux path P2 induced by the current I2 is along the arrow direction as shown in FIG. 12. Specifically, the flux flows along the direction P2a through the first portion 1001-1a of the first magnetic core part 1001-1, the direction P2b through the first magnetic layer 1004, the direction P2c through the first portion 1001-2a of the second magnetic core part 1001-2, the direction P2d through the third portion 1001-2c of the second magnetic core part 1001-2, the direction P2e through the second portion 1001-2b of the second magnetic core part 1001-2, the direction P2f through the second magnetic layer 1005, the direction P2g through the second portion 1001-1b of the first magnetic core part 1001-1, the direction P2h through the third portion 1001-1c of the first magnetic core part 1001-1, and then back to the first portion 1001-1a of the first magnetic core part 1001-1, forming the closed flux path P2.

As can be seen from FIGS. 11 and 12, the flux direction of the current I1 and the flux direction of the current I2 are opposite, thus cause a negative coupling between the two inductors (e.g. L-1 and L-2 in FIG. 1) formed by the first winding 1002, the second winding 1003 and the magnetic core 1001. The negative coupling between the two inductors provides fast transient to a dual-phase power converter utilizing the inductor assembly 100, and meanwhile provides inductors with low DCR (Direct Current Resistance) for the dual-phase power converter.

FIG. 13 is an illustration for the size of the inductor assembly 100 in accordance with an embodiment of the present invention. In one embodiment, a length L1 of the inductor assembly 100 along the first direction “x” is in a range of 5 mm˜20 mm, typically 8.5 mm; a height H1 of the inductor assembly 100 along a second direction “y” is in a range of 1.5 mm˜10 mm, typically 2.3 mm; a width W1 of the inductor assembly 100 along a third direction “z” is in a range of 5 mm˜20 mm, typically 9.4 mm; a width W2 of each winding is in a range of 0.5 mm˜5 mm, typically 2.2 mm; a width W3 of a gap between the first magnetic core part 1001-1 and the second magnetic core part 1001-2 in the third direction “z” is in a range of 0.1 mm˜2 mm, typically 0.5 mm; a thickness H2 of each magnetic core part is in a range of 0.5 mm˜5 mm, typically 0.9 mm; a distance H3 between the first magnetic core part 1001-1 and the second magnetic core part 1001-2 in the second direction “y” is in a range of 0.1 mm˜2 mm, typically 0.5 mm; a thickness H4 of each magnetic layer is in a range of 0.1 mm˜2 mm, typically 0.3 mm. It should be appreciated that the size of the inductor assembly 100 provided above is for illustration but not limiting. As the magnetic core 1001 and the magnetic layers 1004 and 1005 be implemented by different materials, the performance of the inductor assembly 100 may be varying. Persons of ordinary skill in the art could determine the size of the inductor assembly according to the requirement of a specific application and the materials of each elements of the inductor assembly.

The magnetic core 1001 and the magnetic layers 1004 and 1005 could be made of any suitable magnetic material. By implementing the magnetic core parts and the magnetic layers with suitable materials, the inductors formed by the inductor assembly 100 could achieve a desired current-inductance profile.

In various embodiments, the magnetic core parts 1001-1 and 1001-2 are made of high permeability material, like ferrite material, which includes MnZn, NiZn, etc., and the magnetic layers 1004 and 1005 are made of magnetic material with relatively lower magnetic permeability, like powder iron material, which includes FeSiAl, FeSi, FeNi, etc. The magnetic layers 1004 and 1005 provide magnetic paths for the flux induced by the currents I1 and I2. In the embodiment of FIG. 13, air gaps 1007 and 1008 exist together with the magnetic layers 1004/1005 in the gaps between first magnetic core part 1001-1 and the second magnetic core part 1001-2, to prevent saturation of the magnetic core 1001. In other words, the gaps between the first magnetic core part 1001-1 and the second magnetic core part 1001-2 are not fully filled by the magnetic layers. The thickness of each one of the air gaps 1007 and 1008, equaling H3-H4 as shown in FIG. 13, is determined by the permeability of the magnetic layers 1004 and 1005. The higher the permeability of the magnetic layers 1004 and 1005, the thicker the air gaps.

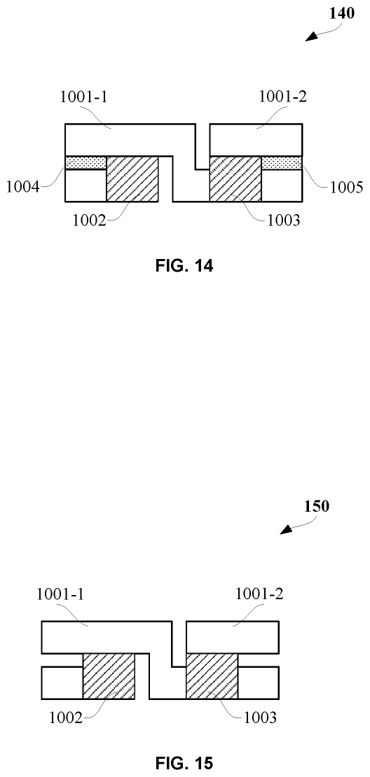

In some embodiments, both the magnetic core parts and the magnetic layers are made of relatively low permeability material, like powder iron. In those embodiments, the gaps between the magnetic core parts may be fully filled by the magnetic layers. FIG. 14 shows a front view of an inductor assembly 140 in accordance with an embodiment of the present invention. As shown in FIG. 14, the magnetic layers 1004 and 1005 fully fills the gaps between the magnetic core parts 1001-1 and 1001-2, leaving no space for the air gaps. In some embodiments, the magnetic core parts and the magnetic layers may be made of same material, and may be integrally-formed.

In some embodiments, with the magnetic core parts implemented by suitable material, the magnetic layers could be removed. FIG. 15 shows a front view of an inductor assembly 150 in accordance with an embodiment of the present invention. In the example of FIG. 15, the magnetic layers are removed, which forms air gaps between the magnetic core parts 1001-1 and 1001-2.

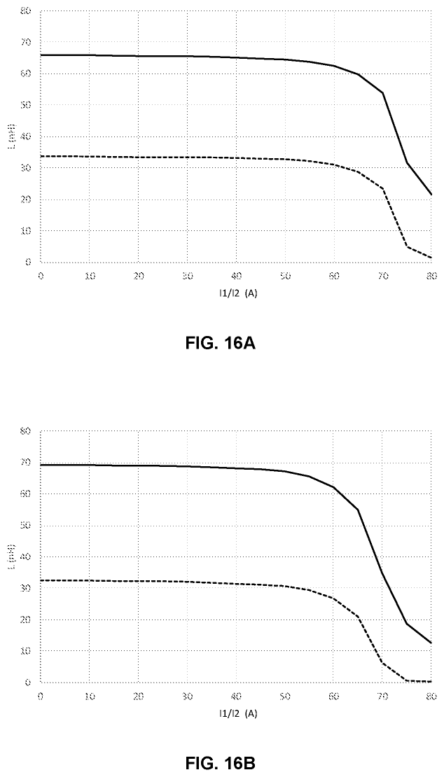

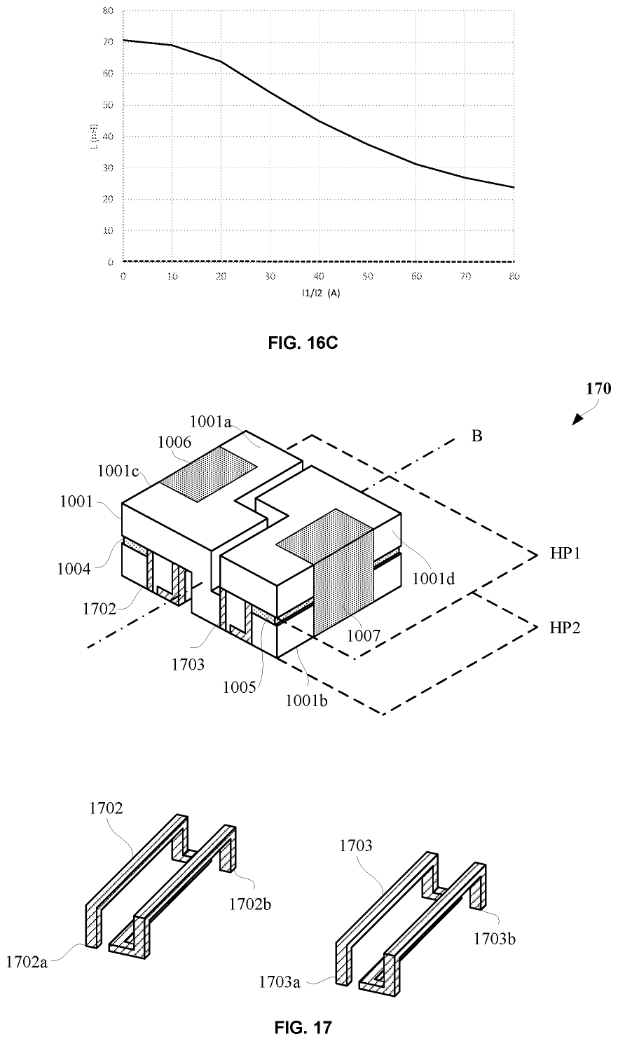

FIG. 16A plots a current-inductance profile for the inductor assembly 100 as shown in FIG. 10 in accordance with an embodiment of the present invention. The inductor assembly 100 having the current-inductance profile shown in FIG. 16A has the magnetic core parts implemented by MnZn, one kind of ferrite material, and the magnetic layers implemented by FeSiAl, and has a size set of (refer to the annotation in FIG. 15): L1=8.5 mm, W1=9.4 mm, W2=2.2 mm, W3=0.5 mm, H1=2.3 mm, H2=0.9 mm, H3=0.5 mm and H4=0.3 mm.

FIG. 16B plots a current-inductance profile for the inductor assembly 150, in accordance with an embodiment of the present invention. The inductor assembly having the current-inductance profile shown in FIG. 16B has the magnetic core parts implemented by MnZn, one kind of ferrite material, and has a size set of (refer to the annotation in FIG. 15): L1=8.5 mm, W1=9.4 mm, W2=2.2 mm, W3=0.5 mm, H1=2.3 mm, H2=0.9 mm and H3=0.5 mm.

FIG. 16C plots a current-inductance profile for the inductor assembly 203 as shown in FIG. 3 with a whole piece magnetic core implemented by FeSiAl in accordance with an embodiment of the present invention. The inductor assembly 203 having the current-inductance profile shown in FIG. 16C has the magnetic core parts implemented by FeSiAl, and has a size set of (refer to the annotation in FIG. 15): L1=8.5 mm, W1=9.4 mm, W2=2.2 mm and H1=2.3 mm.

As mentioned before, each winding together with the magnetic core form an inductor. For example, in FIG. 10, the winding 1002 and the magnetic core 1001 may form the inductor L-1, the winding 1003 and the magnetic core 1001 may form the inductor L-2. Since the windings share a common magnetic core, there is mutual-inductance between the two inductors. The solid lines in FIGS. 16A˜16C represent a self-inductance of the inductor L-1 or L-2 as the currents flowing through the windings changes. The dashed lines in FIGS. 16A˜16C represent the absolute value of a mutual-inductance between the two inductors as the currents flowing through the windings changes. As mentioned before, the unique interlaced structure of the magnetic core 1001 shown in FIG. 10 provides negative coupling between the two inductors. The mutual-inductance between the two inductors are negative. For the purpose of comparison of the self-inductance and the mutual-inductance of the two inductors, the absolute value of the mutual inductance, instead of the actual negative value of the mutual inductance, are shown in FIGS. 16A and 16B. Generally, the current I1 and the current I2 are equal in the inductor assembly with two windings as shown in the previous embodiments. Therefore, the current I1 or the current I2 is also regarded as a current of the inductor assembly. As can be seen from FIG. 16A and FIG. 16B, the inductor assembly 100 with the magnetic layers made of FeSiAl has a better current-inductance profile than the inductor assembly 150, i.e., the self-inductance and the mutual inductance of the inductor assembly 100 drops gently when the current I1/I2 (the current flowing through the windings 1002/1003) exceeds 60 A. Specifically, each inductor has a self-inductance of at least 60 nH for currents between 1 A and 60 A, and at least 50 nH for currents about 70 A in FIG. 16A. Meanwhile, in FIG. 16A, each inductor has a mutual-inductance (absolute value) of at least 30 nH for currents between 1 A and 60 A, and at least 20 nH for currents about 70 A.

As can be seen from FIG. 16B, each inductor has a self-inductance of at least 60 nH for currents between 1 A and 60 A. For the currents above 60 A, the self-inductance drops sharply and is about 35 nH for currents about 70 A. Meanwhile, in FIG. 16B, each inductor has a mutual-inductance (absolute value) of at least 30 nH for currents between 1 A and 50 A. For the currents above 50 A, the mutual-inductance (absolute value) drops and is less than 10 nH for currents about 70 A.

As shown in FIG. 16C, with a whole piece of magnetic core implemented by the powder iron material, the self-inductance of each inductor drops as the current increases, and keeps above 60 nH for currents between 1 A and 20 A. The mutual-inductance of the inductors is positive and is almost zero, which means almost no mutual-inductance between the two inductors sharing a whole piece magnetic core having a cube shape as shown in FIG. 2.

The magnetic core 1001 having the interlaced structure, i.e., assembled by two “Z” shape magnetic core parts in the present invention, eases an assembly process for the magnetic core 1001, and provides a robust structure.

FIG. 17 shows an inductor assembly 170 in accordance with an embodiment of the present invention. The inductor assembly 170 is similar to the inductor assembly 100 in FIG. 10 except for the structure of the windings. The inductor assembly 170 includes a first winding 1702 and a second winding 1703. The first winding 1702 wounds around the second magnetic core part 1001-2, specifically, the first portion 1001-2a, by two turns. The second winding 1703 wounds around the first magnetic core part 1001-1, specifically, the second portion 1001-1b, by two turns. It should be appreciated that the windings may wound around the associated magnetic core parts more than two turns in other embodiments. Compared with the single-turn inductor assembly, the multi-turn inductor assembly is more suitable for low-current (e.g., <10 A) and low-frequency applications since the self-inductance is much higher which is proportional to the squared of number of turns, while with the sacrifice of higher DCR due to longer winding length. When the inductor assembly 170 instead of the inductor assembly 203 is used with the power module 20 as shown in FIG. 3, the first winding 1702 has a first end 1702a connected to the first connecting pillar 202-3, and has a second end 1702b connected to the second connecting pillar 202-4. The second winding 1703 has a first end 1703a connected to the third connecting pillar 202-5, and has a second end 1703b connected to the fourth connecting pillar 202-6.

Obviously many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated and they obviously will be resorted to by those skilled in the art without departing from the spirit and the scope of the invention as hereinafter defined by the appended claims as only a preferred embodiment(s) thereof has been disclosed.

What is claimed is:

1. A power module, comprising:
a bottom substrate, having a first surface and a second surface opposite to the first surface;
a device substrate, arranged on the bottom substrate, wherein the device substrate has a first surface and a second surface opposite to the first surface of the device substrate, and wherein the second surface of the device substrate faces the first surface of the bottom substrate; and
an inductor assembly, arranged on the device substrate, wherein the inductor assembly has a first surface and a second surface opposite to the first surface of the inductor assembly, and wherein the second surface of the inductor assembly faces the first surface of the device substrate;
wherein the inductor assembly comprises:
a first winding;
a second winding;
a first magnetic core part, having a first portion disposed on a first horizontal level, a second portion disposed on a second horizontal level, and a connecting portion connecting the first portion and the second portion of the first magnetic core part; and
a second magnetic core part, having a first portion disposed on the second horizontal level, a second portion disposed on the first horizontal level, and a connecting portion connecting the first portion and the second portion of the second magnetic core part;
wherein the first magnetic core part and the second magnetic core part are assembled to accommodate the first winding between the first portion of the first magnetic core part and the first portion of the second magnetic core part, and to accommodate the second winding between the second portion of the first magnetic core part and the second portion of the second magnetic core part.

2. The power module of claim 1, wherein the device substrate comprises:
a first power device chip, embedded within the device substrate, wherein the first power device chip has a first surface and a second surface, and wherein the first surface of the first power device chip is covered by a first top heat layer, the second surface of the first power device chip has a plurality of pins or pads exposed on the second surface of the device substrate, and connected to the bottom substrate; and
a second power device chip, embedded within the device substrate, wherein the second power device chip has a first surface and a second surface, and wherein the first surface of the second power device chip is covered by a second top heat layer, the second surface of the second power device chip has a plurality of pins or pads exposed on the second surface of the device substrate, and connected to the bottom substrate.

3. The power module of claim 2, wherein:
the first winding has a first end and a second end connected out of the second surface of the inductor assembly to the device substrate; and
the second winding has a first end and a second end connected out of the second surface of the inductor assembly to the device substrate.

4. The power module of claim 3, wherein the device substrate comprises:
a first connecting pillar, having a first end connected to the first end of the first winding and a second end connected to the bottom substrate;
a second connecting pillar, having a first end connected to the second end of the first winding and a second end connected to the bottom substrate;
a third connecting pillar, having a first end connected to the first end of the second winding and a second end connected to the bottom substrate; and
a fourth connecting pillar, having a first end connected to the second end of the second winding and a second end connected to the bottom substrate.

5. The power module of claim 4, wherein each one of the first power device chip and the second power device chip comprises:
an input pin;
a switching pin;
a ground pin;
a driving pin;
a first switch, having a first terminal coupled to the input pin, a second terminal coupled to the switching pin, and a control terminal configured to receive a first driving signal;
a second switch, having a first terminal coupled to the switching pin, a second terminal coupled to the ground pin, and a control terminal configured to receive a second driving signal; and
a driver, coupled to the driving pin to receive a phase control signal, and to provide the first driving signal and the second driving signal based on the phase control signal;
wherein the switching pin of the first power device chip is electrically connected to the first end of the first winding via the first connecting pillar and the bottom substrate, and the switching pin of the second power device chip is electrically connected to the first end of the second winding via the third connecting pillar and the bottom substrate.

6. The power module of claim 5, wherein the second surface of the bottom substrate comprises:
an input pad area, having at least one pad electrically connected to the input pin of each one of the first power device chip and the second power device chip;
a ground pad area, having at least one pad electrically connected to the ground pin of each one of the first power device chip and the second power device chip;
a signal pad area, having at least two pads electrically connected to the driving pin of the first power device chip and the driving pin of the second power device chip respectively;
a first output voltage pad area, having at least one pad electrically connected to the inductor assembly via the bottom substrate and the second connecting pillar; and
a second output voltage pad area, having at least one pad electrically connected to the inductor assembly via the bottom substrate and the fourth connecting pillar.

7. The power module of claim 3, wherein:
the first winding has a middle portion located between the first portion of the first magnetic core part and the first portion of the second magnetic core part, wherein the middle portion of the first winding has a length parallel to the first surface of the device substrate and extending along a first direction; and
the second winding has a middle portion located between the second portion of the first magnetic core part and the second portion of the second magnetic core part, wherein the middle portion of the second winding has a length parallel to the first surface of the device substrate and extending along the first direction.

8. The power module of claim 7, wherein the inductor assembly further comprises:
a first magnetic layer, located between the first portion of the first magnetic core part and the first portion of the second magnetic core part, and alongside the middle portion of the first winding, wherein the first magnetic layer has a length extending along the first direction; and
a second magnetic layer, located between the second portion of the first magnetic core part and the second portion of the second magnetic core part, and alongside the middle portion of the second winding, wherein the second magnetic layer has a length extending along the first direction.

9. The power module of claim 8, wherein the first magnetic layer and the second magnetic layer are made of powder iron.

10. The power module of claim 3, wherein each one of the first winding and the second winding has an upside-down “U” shape.

11. The power module of claim 3, wherein:
the first winding wounds around the second magnetic core part more than one turns; and
the second winding wounds around the first magnetic core part more than one turns.

12. The power module of claim 2, wherein the inductor assembly further comprises:
a first heat sink layer, having a “C” shape partially wrapping the inductor assembly, wherein the first heat sink layer has a first portion partially covering the first surface of the inductor assembly, a second portion partially covering the second surface of the inductor assembly and meanwhile attached to the first top heat layer covering the first power device chip, and a third portion partially covering a third surface of the inductor assembly, and wherein the third surface of the inductor assembly is vertical to the first surface and the second surface of the inductor assembly, and is parallel to the middle portion of the first winding; and
a second heat sink layer, having a “C” shape partially wrapping the inductor assembly, wherein the second heat sink layer has a first portion partially covering the first surface of the inductor assembly, a second portion partially covering the second surface of the inductor assembly and meanwhile attached to the second top heat layer covering the second power device chip, and a third portion partially covering a fourth surface of the inductor assembly, and wherein the fourth surface of the inductor assembly is vertical to the first surface and the second surface of the inductor assembly, and is parallel to the middle portion of the second winding;
wherein the third surface and the fourth surface of the inductor assembly are opposite.

13. The power module of claim 1, wherein the first magnetic core part and the second magnetic core part are made of ferrite.

14. An inductor assembly having a first surface and a second surface opposite to the first surface, comprising:
a first winding;
a second winding;
a first magnetic core part, having a first portion disposed on a first horizontal level, a second portion disposed on a second horizontal level, and a connecting portion connecting the first portion and the second portion of the first magnetic core part; and
a second magnetic core part, having a first portion disposed on the second horizontal level, a second portion disposed on the first horizontal level, and a connecting portion connecting the first portion and the second portion of the second magnetic core part;
wherein the first magnetic core part and the second magnetic core part are assembled to accommodate the first winding between the first portion of the first magnetic core part and the first portion of the second magnetic core part, and to accommodate the second winding between the second portion of the first magnetic core part and the second portion of the second magnetic core part; and
wherein the connecting portion of the first magnetic core part and the connecting portion of the second magnetic core part are located at a central axis of the inductor assembly, and the first winding and the second winding are located on the opposite sides of the central axis of the inductor assembly.

15. The inductor assembly of claim 14, wherein:
the first winding has a first end and a second end connected out of the second surface of the inductor assembly; and
the second winding has a first end and a second end connected out of the second surface of the inductor assembly.

16. The inductor assembly of claim 15, wherein each one of the first winding and the second winding has an upside-down “U” shape.

17. The inductor assembly of claim 15, wherein:
the first winding wounds around the second magnetic core part more than one turns; and
the second winding wounds around the first magnetic core part more than one turns.

18. The inductor assembly of claim 14, further comprising:
a first magnetic layer, located between the first portion of the first magnetic core part and the first portion of the second magnetic core part; and
a second magnetic layer, located between the second portion of the first magnetic core part and the second portion of the second magnetic core part.

19. The inductor assembly of claim 18, wherein the first magnetic layer and the second magnetic layer are made of powder iron, and the magnetic core parts are made of ferrite.

20. The inductor assembly of claim 19, wherein a self-inductance of the inductor assembly is at least 60 nH for currents between 1 A and 60 A, and at least 50 nH for currents about 70 A, and wherein a mutual-inductance of the inductor assembly is negative and has an absolute value of at least 30 nH for currents between 1 A and 60 A, and at least 20 nH for currents about 70 A.

21. The inductor assembly of claim 14, further comprising:
a first heat sink layer having a “C” shape partially wrapping the inductor assembly, wherein the first heat sink layer has a first portion partially covering the first surface of the inductor assembly, a second portion partially covering the second surface of the inductor assembly, and a third portion partially covering a third surface of the inductor assembly, and wherein the third surface of the inductor assembly is vertical to the first surface and the second surface of the inductor assembly, and is parallel to the middle portion of the first winding; and
a second heat sink layer having a “C” shape partially wrapping the inductor assembly, wherein the second heat sink layer has a first portion partially covering the first surface of the inductor assembly, a second portion partially covering the second surface of the inductor assembly, and a third portion partially covering a fourth surface of the inductor assembly, and wherein the fourth surface of the inductor assembly is vertical to the first surface and the second surface of the inductor assembly, and is parallel to the middle portion of the second winding;
wherein the third surface and the fourth surface of the inductor assembly are opposite.

22. The inductor assembly of claim 14, wherein the first magnetic core part and the second magnetic core part are made of ferrite, and wherein the inductor assembly provides a self-inductance of at least 60 nH for currents between 1 A and 60 A, and at least 35 nH for currents about 70 A, and provides a negative mutual-inductance which has an absolute value of at least 30 nH for currents between 1 A and 60 A, and at least 10 nH for currents about 70 A.

23. An inductor assembly having a first surface and a second surface opposite to the first surface, comprising:
a first winding;
a second winding;
a first magnetic core part, having a first portion disposed on a first horizontal level, a second portion disposed on a second horizontal level, and a connecting portion connecting the first portion and the second portion of the first magnetic core part; and
a second magnetic core part, having a first portion disposed on the second horizontal level, a second portion disposed on the first horizontal level, and a connecting portion connecting the first portion and the second portion of the second magnetic core part;
wherein the first magnetic core part and the second magnetic core part are assembled to accommodate the first winding between the first portion of the first magnetic core part and the first portion of the second magnetic core part, and to accommodate the second winding between the second portion of the first magnetic core part and the second portion of the second magnetic core part; and
wherein the inductor assembly provides a self-inductance of at least 60 nH for currents between 1 A and 60 A, and provides a negative mutual-inductance which has an absolute value of at least 30 nH for currents between 1 A and 60 A.

24. The inductor assembly of claim 23, wherein:
the first winding has a first end and a second end connected out of the second surface of the inductor assembly; and
the second winding has a first end and a second end connected out of the second surface of the inductor assembly.

25. The inductor assembly of claim 24, wherein each one of the first winding and the second winding has an upside-down “U” shape.

26. The inductor assembly of claim 24, wherein:
the first winding wounds around the second magnetic core part more than one turns; and
the second winding wounds around the first magnetic core part more than one turns.

27. The inductor assembly of claim 23, further comprising:
a first magnetic layer, located between the first portion of the first magnetic core part and the first portion of the second magnetic core part; and
a second magnetic layer, located between the second portion of the first magnetic core part and the second portion of the second magnetic core part.

28. The inductor assembly of claim 27, wherein the first magnetic core part and the second magnetic core part are made of ferrite, the first magnetic layer and the second magnetic layer are made of powder iron, and wherein the inductor assembly provides a self-inductance of at least 60 nH for currents between 1 A and 60 A, and at least 50 nH for currents about 70 A, and provides a negative mutual-inductance which has an absolute value of at least 30 nH for currents between 1 A and 60 A, and at least 20 nH for currents about 70 A.

29. The inductor assembly of claim 23, further comprising:
a first heat sink layer having a “C” shape partially wrapping the inductor assembly, wherein the first heat sink layer has a first portion partially covering the first surface of the inductor assembly, a second portion partially covering the second surface of the inductor assembly, and a third portion partially covering a third surface of the inductor assembly, and wherein the third surface of the inductor assembly is vertical to the first surface and the second surface of the inductor assembly, and is parallel to the middle portion of the first winding; and
a second heat sink layer having a “C” shape partially wrapping the inductor assembly, wherein the second heat sink layer has a first portion partially covering the first surface of the inductor assembly, a second portion partially covering the second surface of the inductor assembly, and a third portion partially covering a fourth surface of the inductor assembly, and wherein the fourth surface of the inductor assembly is vertical to the first surface and the second surface of the inductor assembly, and is parallel to the middle portion of the second winding;
wherein the third surface and the fourth surface of the inductor assembly are opposite.
